(19) United States
(12) Patent Application Publication
(10) Pub. No.: US 2025/0278038 A1
(43) Pub. Date: Sep. 4, 2025

(54) DEVELOPER CONTAINER AND IMAGE FORMING APPARATUS

(71) Applicant: FUJIFILM Business Innovation Corp., Tokyo (JP)

(72) Inventor: Yosuke NINOMIYA, Kanagawa (JP)

(73) Assignee: FUJIFILM Business Innovation Corp., Tokyo (JP)

(21) Appl. No.: 18/822,294

(22) Filed: Sep. 2, 2024

(30) Foreign Application Priority Data
Feb. 29, 2024 (JP) 2024-030053

(51) Int. Cl. G03G 15/08; G03G 15/01

(52) U.S. Cl. CPC G03G 15/0872; G03G 15/0121; G03G 15/0189; G03G 15/0886

(57) ABSTRACT

A developer container includes: an accommodation portion that accommodates a developer; a discharge port through which the developer is discharged from an outer peripheral portion of the accommodation portion on a front end side in a mounting direction; an opening and closing portion that opens and closes the discharge port from an outside; an attachment portion that surrounds the discharge port and to which the opening and closing portion is movably attached, in which the attachment portion has an extending portion extending toward the front end side in the mounting direction, and the extending portion is provided with a support portion that supports the extending portion on a surface opposite to the opening and closing portion.

### CROSS-REFERENCE TO RELATED APPLICATIONS

This application is based on and claims priority under 35 USC 119 from Japanese Patent Application No. 2024-030053 filed Feb. 29, 2024.

### BACKGROUND

### (i) Technical Field

The present invention relates to a developer container and an image forming apparatus.

### (ii) Related Art

JP2020-170150A (Paragraph 0053 and FIG. 4) discloses a powder container including a toner bottle that accommodates a toner, an outlet port through which the toner flows out, a shutter that opens and closes the outlet port from an outside, and an attachment portion to which the shutter is movably attached.

### SUMMARY

There is a developer container including an attachment portion to which an opening and closing portion that opens and closes a discharge port for a developer is movably attached on a front end side in a mounting direction of an accommodation portion for the developer. In such a developer container, from the viewpoint of securing sealability of the discharge port by the opening and closing portion at the attachment portion, widening a flat surface portion of a portion of the attachment portion facing the opening and closing portion is desired.

Aspects of non-limiting embodiments of the present disclosure relate to a developer container that enables, regarding an extending portion of the attachment portion that extends toward a front end side in a mounting direction, compared to a case where the extending portion is not provided with a support portion that supports the extending portion, the extending portion to become a portion that is less likely to be deformed or damaged by providing a flat surface portion that is made wider to secure the sealability of the discharge port by the opening and closing portion.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developer container including:
an accommodation portion that accommodates a developer;
a discharge port through which the developer is discharged from an outer peripheral portion of the accommodation portion on a front end side in a mounting direction;
an opening and closing portion that opens and closes the discharge port from an outside; an attachment portion that surrounds the discharge port and to which the opening and closing portion is movably attached,
in which the attachment portion has an extending portion extending toward the front end side in the mounting direction, and
the extending portion is provided with a support portion that supports the extending portion on a surface opposite to the opening and closing portion.

### BRIEF DESCRIPTION OF THE DRAWINGS

Exemplary embodiment(s) of the present invention will be described in detail based on the following figures, wherein:

FIG. 1 is a schematic view of an image forming apparatus including a developer container according to a first exemplary embodiment;

FIG. 2 is a schematic view showing a state at the time of mounting of a developer container and a mounting portion;

FIG. 3 is a perspective view of the developer container according to the first exemplary embodiment;

FIG. 4 is an exploded perspective view of the developer container in FIG. 3;

FIG. 5 is a perspective view showing a portion of the developer container on a front end side in a mounting direction;

FIG. 6 is a perspective view including a cross section taken along line VI-VI of the developer container in FIG. 5;

FIG. 7A is a bottom perspective view showing a state where an opening and closing portion of a portion of the developer container on the front end side in the mounting direction is closed, and FIG. 7B is a bottom perspective view obliquely showing a state where the opening and closing portion is opened at the portion in FIG. 7A;

FIG. 8 is a perspective view showing a part of the developer container and the mounting portion;

FIG. 9 is a perspective view of an opening and closing guide body in the mounting portion;

FIG. 10 is a perspective view of an end portion holding body of the developer container;

FIG. 11A is a front view showing a state where the developer container is mounted in the opening and closing guide body in the mounting portion, and FIG. 11B is a front view including a partial cross section showing a state where a part of the opening and closing guide body is omitted in the state of FIG. 11A;

FIG. 12 is a side view including a cross section taken along line VI-VI of the developer container in FIG. 5; and

FIG. 13 is a front view showing another configuration example of a support portion and an identification shape portion.

### DETAILED DESCRIPTION

Hereinafter, exemplary embodiments for carrying out the present invention will be described.

### First Exemplary Embodiment

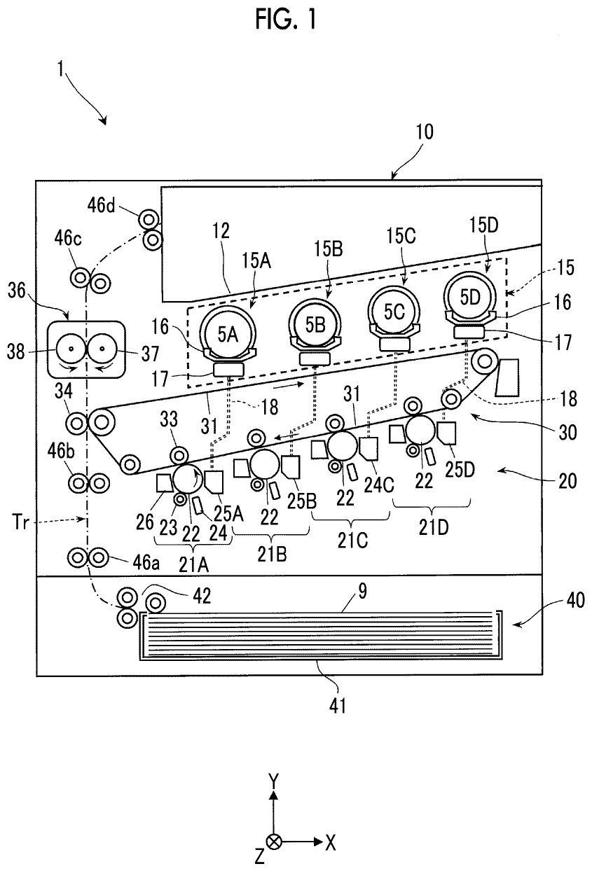

FIG. 1 is a schematic view of an image forming apparatus 1 including a developer container 5 according to a first exemplary embodiment of the present invention.

In the present specification and the drawings, substantially the same constituent elements are denoted by the same reference numerals. In addition, in the present specification, the duplicated description of the same constituent element will be omitted.

### (1) Image Forming Apparatus

As shown in FIG. 1, in the image forming apparatus 1, an image forming section 20 that forms an image consisting of a developer on paper 9 and a paper supply section 40 that supplies the paper 9 to the image forming section 20 are disposed inside a housing 10.

In addition, the image forming apparatus 1 is provided with a discharge and accommodation portion 12 that discharges and accommodates the paper 9 on which the image is formed, for example, in an upper portion of the housing 10.

Furthermore, the image forming apparatus 1 is provided with a mounting portion 15, in which the developer container 5 is attachably and detachably mounted, on a part of the housing 10.

The image forming section 20 has a plurality of image forming units 21A, 21B, 21C, and 21D, an intermediate transfer unit 30, and a fixing unit 36.

In the image forming units 21A, 21B, 21C, and 21D, images of predetermined colors (A, B, C, and D) consisting of the developer are respectively formed on photosensitive drums 22 by an electrophotographic method.

Examples of the predetermined colors (A, B, C, and D) include colors such as black, cyan, magenta, and yellow.

Specifically, in each of the image forming units 21A, 21B, 21C, and 21D, the corresponding photosensitive drum 22 rotates in a direction indicated by an arrow.

Then, an outer peripheral surface of each of the photosensitive drums 22 is charged to a predetermined surface potential by a corresponding charging devices 23.

Subsequently, on the charged outer peripheral surface of each of the photosensitive drums 22, image exposure of each color component corresponding to image information is performed by each of latent image forming devices 24. Accordingly, electrostatic latent images of the predetermined color components are distributed and exclusively formed on the outer peripheral surfaces of the respective photosensitive drums 22.

The image information is input from an external source such as an external connection device (not shown) connected to the image forming apparatus 1.

Subsequently, in the photosensitive drums 22, the electrostatic latent images formed on the outer peripheral surfaces thereof are respectively developed by the developers of the corresponding colors respectively supplied from developing devices 25A, 25B, 25C, and 25D.

As the developer, for example, a two-component developer containing a toner and a carrier is used. In a case where the developer is the two-component developer, a toner image consisting of a toner of a predetermined color (A, B, C, or D) is obtained as a developed image.

Since the developing devices 25 differ in that the developer containing the toner of the predetermined color (A, B, C, or D) is used separately, the developing devices 25 are displayed as developing devices 25A, 25B, 25C, and 25D.

Accordingly, the toner images of the predetermined colors are respectively formed on the outer peripheral surfaces of the corresponding photosensitive drums 22.

In the intermediate transfer unit 30, the toner images of the predetermined colors respectively formed by the image forming units 21A, 21B, 21C, and 21D are temporarily held on an intermediate transfer belt 31 by primary transfer, followed by secondary transfer to the paper 9.

Specifically, the intermediate transfer belt 31 is rotatably stretched around a plurality of rolls and is rotated in a direction indicated by an arrow.

Subsequently, the toner images on the photosensitive drums 22 are sequentially primarily transferred to an outer peripheral surface of the intermediate transfer belt 31 by a primary transfer device 33.

Thereafter, the intermediate transfer belt 31 transports the toner image primarily transferred to the outer peripheral surface thereof to a secondary transfer position facing a secondary transfer device 34. At the secondary transfer position, the toner image on the intermediate transfer belt 31 is secondarily transferred to the paper 9 supplied from the paper supply section 40 by the secondary transfer device 34.

In the paper supply section 40, the paper 9 is sent one by one from an accommodation body 41 in which the paper 9 is accommodated to the image forming section 20 by a sending device 42.

There are cases where a plurality of sets of the accommodation body 41 and the sending device 42 are provided.

The paper 9 sent by the sending device 42 is transported through a paper feeding path portion of a transport path Tr constituted by a predetermined number of transport roll pairs 46a and 46b, paper guide members (not shown), and the like.

At this time, the paper 9 is sent to the secondary transfer position of the intermediate transfer unit 30 by the transport roll pair 46b in synchronization with the secondary transfer, and the toner image is secondarily transferred to one surface of the paper 9. The paper 9 after the secondary transfer of the toner image is sent from the secondary transfer position toward a fixing unit 36

In the fixing unit 36, the paper 9 on which the toner image has been secondarily transferred is introduced into a fixing processing portion (nip portion) formed between a heating rotating body 37 and a pressurizing rotating body 38, which rotate in a pressure contact state inside the housing.

Accordingly, an unfixed toner image is heated and pressurized when passing through the fixing processing portion, and is fixed on the paper 9 as an image.

As described above, the image consisting of the developer (toner) is formed on one surface of the paper 9.

Finally, in the image forming apparatus 1, the paper 9 on which the image is formed is transported and accommodated so that the paper 9 is discharged to the discharge and accommodation portion 12 through a discharge path portion of the transport path Tr.

The discharge path portion of the transport path Tr is configured with a predetermined number of transport roll pairs 46c and 46d, paper guide members (not shown), and the like.

### Mounting Portion of Developer Container

In the image forming apparatus 1, as the developer container 5, as shown in FIG. 1, four developer containers 5A, 5B, 5C, and 5D in which the developers of the predetermined colors (A, B, C, and D) are exclusively accommodated are used.

The image forming apparatus 1 is provided with mounting portions 15A, 15B, 15C, and 15D for attachably and detachably mounting the developer containers 5A, 5B, 5C, and 5D, respectively, in a part of the housing 10.

As shown in FIG. 1, the mounting portions 15A, 15B, 15C, and 15D in the first exemplary embodiment are provided in a portion between the intermediate transfer unit 30 and the discharge and accommodation portion 12.

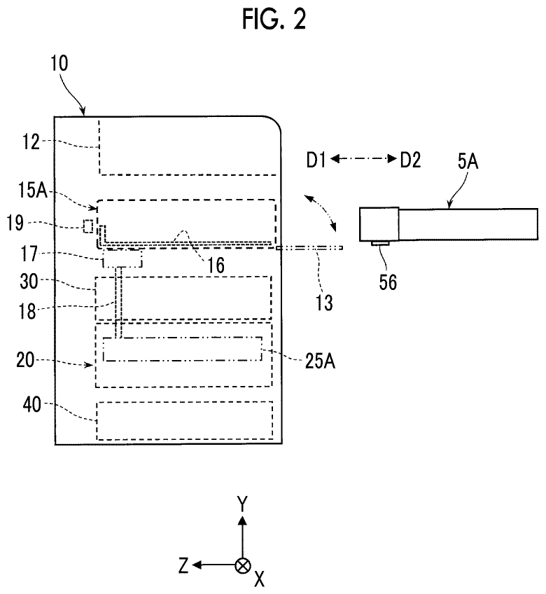

In addition, as shown in FIG. 2, the mounting portions 15A, 15B, 15C, and 15D are formed as storage space sections that are depressed from a front surface, which is one of side surfaces of the housing 10, toward a rear side (in a direction indicated by an arrow Z).

Furthermore, as shown in FIG. 2, the mounting portion 15A or the like is in a state of being opened to the outside and in a state of being closed from the outside by an opening and closing door 13 that is rotatably moved with a lower end as a fulcrum on a front surface side of the housing 10.

The developer containers 5A, 5B, 5C, and 5D are attachable to and detachable from the mounting portions 15A, 15B, 15C, and 15D by being operated to be inserted into and removed from the mounting portions 15A, 15B, 15C, and 15D in directions indicated by arrows D1 and D2. The direction indicated by the arrow D1 in FIG. 2 and the like indicates a mounting direction (insertion direction), and the direction indicated by the arrow D2 indicates a detachment direction (pull-out direction).

Details of the developer containers 5A, 5B, 5C, and 5D will be described later.

In addition, in the image forming apparatus 1, the developer is consumed and reduced in amount in the developing devices 25A, 25B, 25C, and 25D by an image forming operation.

Therefore, in a case where the developer is reduced to a predetermined amount, the developing devices 25A, 25B, 25C, and 25D are respectively replenished with the developers (toner in this example) of the corresponding colors (A, B, C, and D) from the developer containers 5A, 5B, 5C, and 5D.

In the mounting portions 15A, 15B, 15C, and 15D, a mounting platform 16 and a replenishing device 17 are each disposed inside storage spaces in which the developer containers 5A, 5B, 5C, and 5D are respectively stored, as shown in FIG. 1.

The mounting platform 16 is a structure in which the developer containers 5A, 5B, 5C, and 5D are mounted and held in the storage space, respectively. The replenishing device 17 is a device that sends out and replenishes a predetermined amount of the developer discharged from the developer containers 5A, 5B, 5C, and 5D to the corresponding developing devices 25A, 25B, 25C, and 25D.

In addition, a replenishing transport path 18 is provided in each of the mounting portions 15A, 15B, 15C, and 15D.

The replenishing transport path 18 is a developer transport path disposed to connect the replenishing devices 17 to the corresponding developing devices 25A, 25B, 25C, and 25D.

### (2) Developer Container

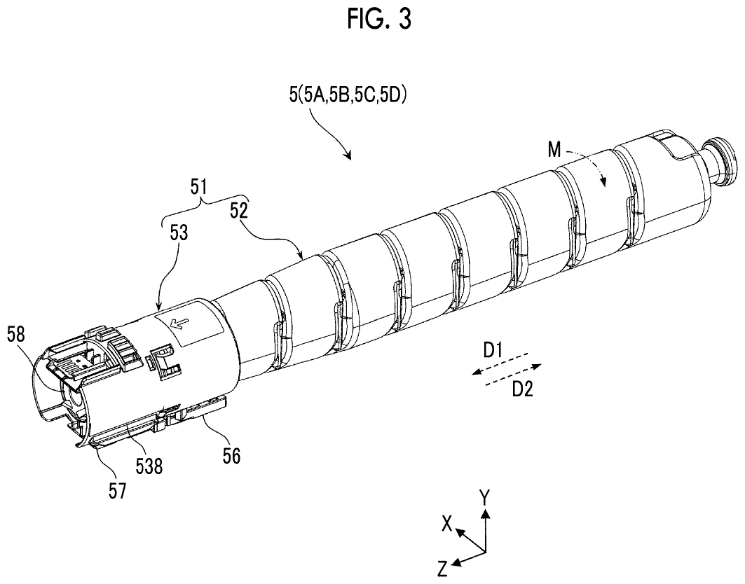

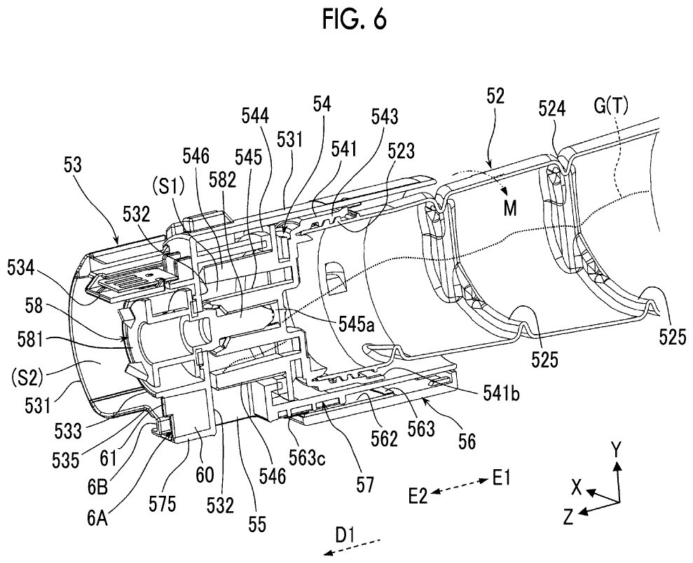

As shown in FIG. 3, each of the developer containers 5A, 5B, 5C, and 5D includes an accommodation portion 51 that accommodates a predetermined developer G (see FIG. 6 and the like).

In a case where the developer containers 5A, 5B, 5C, and 5D accommodate only toner T (see FIG. 6 and the like) of the two-component developer as the developer G, the developer container 5A, 5B, 5C, and 5D are also referred to as, for example, a toner cartridge.

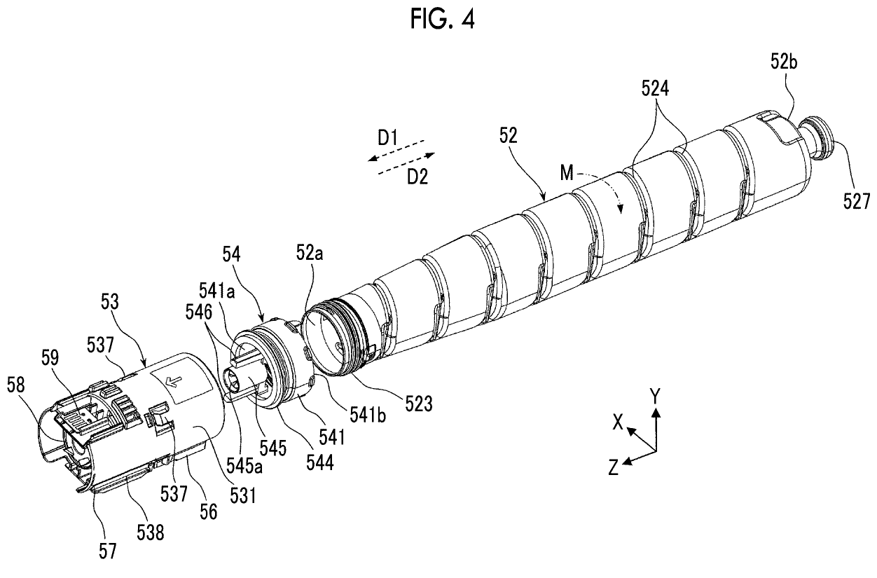

As shown in FIG. 4, the accommodation portion 51 in the first exemplary embodiment is constituted by an accommodation main body 52, an end portion holding body 53, and an agitating body 54.

The accommodation portion 51 has a structure in which the agitating body 54 is attached to one end portion of the accommodation main body 52 and the portion to which the agitating body 54 is attached is rotatably held by the end portion holding body 53.

### Accommodation Main Body

The accommodation main body 52 is a portion that accommodates the developer G, at least the toner T in this example.

The accommodation main body 52 in the first exemplary embodiment has a substantially cylindrical structure as a whole in which one end is open and the other end is closed. That is, in the accommodation main body 52, an end portion 52a on a downstream side in the mounting direction D1 of the accommodation portion 51, and thus the developer container 5, is open, and an end portion 52b on an upstream side in the mounting direction D1 is closed.

In addition, the accommodation main body 52 is configured to rotate in a predetermined direction M in a case where the accommodated developer G (toner T) is discharged during replenishment.

Incidentally, the mounting direction D1 of the developer containers 5A, 5B, 5C, and 5D is a direction along a longitudinal direction of the accommodation main body 52 having a form elongated in one direction.

In addition, the accommodation main body 52 is provided with a coupled portion 523 to which the agitating body 54 is coupled, at the end portion 52a that is open. The coupled portion 523 is a structural portion with, for example, threads formed on an outer peripheral surface of the accommodation main body 52.

In addition, the accommodation main body 52 is provided with a grip portion 527 having a shape protruding from the end portion 52b toward the upstream side in the mounting direction D1, at the end portion 52b. The grip portion 527 is used as a portion that is gripped and held by a user by hand in a case where the developer container 5 is mounted in the mounting portion 15.

Furthermore, the accommodation main body 52 is provided with a groove 524 that extends in a helical shape on the outer peripheral surface thereof. As shown in FIG. 6 and the like, the groove 524 is formed with a ridge portion 525 on an inner wall surface of the accommodation main body 52, the ridge portion 525 extending in a helical shape to be raised inwardly and to substantially correspond to the shape of the groove 524.

The helical ridge portion 525 functions as transporting means that transports the accommodated developer G (toner T) to be moved toward a discharge port 55, which will be described below, when the accommodation main body 52 is rotated in the predetermined direction M.

### End Portion Holding Body

The end portion holding body 53 is a portion that rotatably holds the end portion 52a of the accommodation main body 52 via the agitating body 54.

In addition, the end portion holding body 53 also serves as a portion on a front end side in the mounting direction D1 of the developer container 5 or the accommodation portion 51.

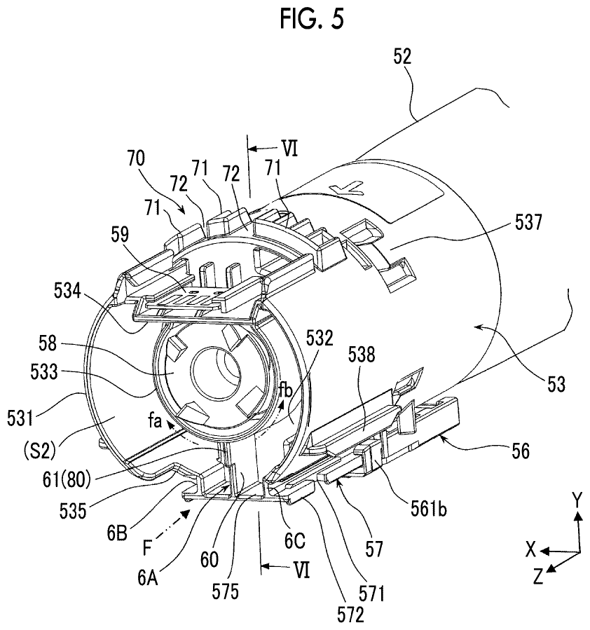

As shown in FIGS. 5 and 6, the end portion holding body 53 in the first exemplary embodiment has a cylindrical main body portion 531.

An internal space of the main body portion 531 is divided into front and rear sections by a partition wall 532 in the mounting direction D1.

As shown in FIG. 6, the main body portion 531 has a first internal space S1 that is present on the upstream side in the mounting direction D1 from the partition wall 532.

The first internal space S1 is a space that accommodates the developer G (toner T) while accommodating a part of the accommodation main body 52 to be held via the agitating body 54.

The partition wall 532 is an end portion on the downstream side in the mounting direction D1 in an accommodation space of the accommodation portion 51 in which the developer G (toner T) is accommodated. In other words, the partition wall 532 also serves as a portion that functions as a lid that closes the open end portion 52a of the accommodation main body 52 together with the first internal space S1 in a state where the agitating body 54 is interposed.

In addition, the main body portion 531 has a second internal space S2 that is present on the downstream side in the mounting direction D1 from the partition wall 532.

The second internal space S2 is a space in which a shaft coupling 58 and the like on a driven side are disposed.

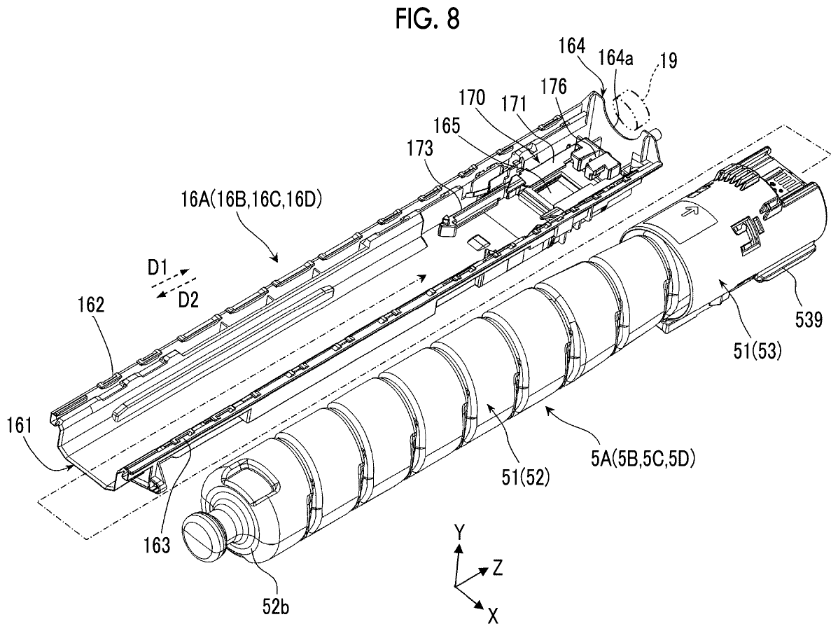

The shaft coupling 58 on the driven side is coupled to a shaft coupling 19 (see FIG. 8) on a drive side, which is detachably connected to transmit rotational power disposed on a mounting portion 15 side.

The shaft coupling 58 on the driven side is also referred to as a coupling on a container side. In addition, the shaft coupling 19 on the drive side is also referred to as a coupling on a mounting portion side.

As shown in FIG. 6, the shaft coupling 58 on the driven side has a connection portion 581 and a transmission shaft portion 582.

The connection portion 581 is a portion in which a plurality of projection portions are provided on a circular main body having an outer diameter smaller than an inner diameter of the second internal space S2. The transmission shaft portion 582 is a shaft that protrudes along the upstream side in the mounting direction D1 from a center of an end portion of the connection portion 581 on the upstream side in the mounting direction D1.

The shaft coupling 58 on the driven side is attached in a state of being rotatably supported by an attachment hole provided to pass through a central portion of the partition wall 532. In this case, the transmission shaft portion 582 is disposed to pass through the central portion of the partition wall 532 and enter the first internal space S1.

The second internal space S2 is provided with a covering portion 533 that covers and protects a periphery of (the connection portion 581 of) the shaft coupling 58 on the driven side is provided in the second internal space S2.

The covering portion 533 is formed as a structural portion that protrudes from the central portion of the partition wall 532 in the mounting direction D1. Specifically, the covering portion 533 is formed as a structural portion that is curved in a cylindrical shape with an opening at an upper portion.

### Discharge Port

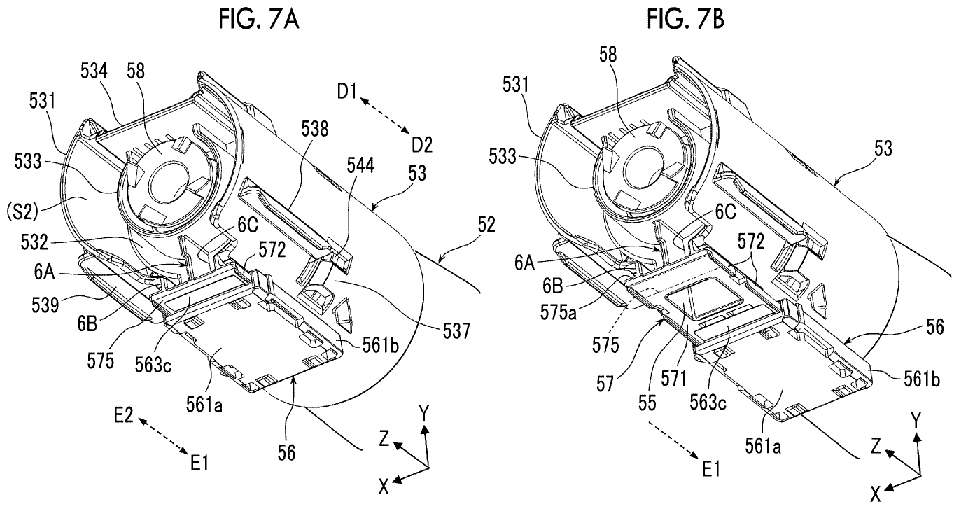

In addition, as shown in FIG. 6 and FIG. 7A, the end portion holding body 53 is provided with the discharge port 55 in a lower section of the first internal space S1 of the main body portion 531 to discharge the accommodated developer G (toner T).

The discharge port 55 in the first exemplary embodiment is formed as an opening having an approximately rectangular opening shape and extending from an inside of the first internal space S1 to an outer peripheral surface (outer peripheral portion) of the main body portion 531. In addition, the discharge port 55 is provided in a form in which one side surface (inner wall) thereof is formed of a part of the partition wall 532 (see FIG. 6).

The discharge port 55 is opened and closed from the outside by an opening and closing portion 56.

### Opening and Closing Portion of Discharge Port

The opening and closing portion 56 is an opening and closing lid that is slidably moved to open and close the discharge port 55. The opening and closing portion 56 is also referred to as a shutter.

The opening and closing portion 56 is present at a position to close the discharge port 55 when the developer container 5 is not mounted in the mounting portion 15, or when the developer container 5 is being mounted in the mounting portion 15 or is being detached from the mounting portion 15. On the other hand, the opening and closing portion 56 is present at a position to open the discharge port 55 immediately before the developer container 5 is mounted in the mounting portion 15 or when the mounting is completed.

The opening and closing portion 56 in the first exemplary embodiment is configured as a rectangular plate-shaped lid. As shown in FIG. 7A and the like, the opening and closing portion 56 has a rectangular plate-shaped opening and closing main body 561a and attachment side wall portions 561b. The attachment side wall portions 561b are portions that rise upward from both end portions of the opening and closing main body 561a along opening and closing directions E1 and E2 described below and are attached to side wall portions 572 of an attachment portion 57 described below.

In addition, as shown in FIG. 6, the opening and closing portion 56 is provided with a sealing (seal) material 562 on a surface (inner surface) facing the discharge port 55, the sealing material 562 covering the discharge port 55 when the opening and closing portion 56 is moved to the position to close the discharge port 55 and sealing the discharge port 55 to prevent leakage of the developer G (toner T).

Furthermore, as shown in FIG. 6 and the like, the opening and closing portion 56 is provided with a peripheral sealing sheet 563 on the inner surface, the peripheral sealing sheet 563 surrounding the sealing material 562. The peripheral sealing sheet 563 has a shape having a protruding portion 563c that protrudes toward the downstream side in the mounting direction D1 from the opening and closing portion 56.

### Attachment Portion of Opening and Closing Portion

Furthermore, as shown in FIGS. 5, 6, and 7A, the end portion holding body 53 is provided with the attachment portion 57 to which the opening and closing portion 56 is movably attached.

The attachment portion 57 is a plate-like structural portion that is formed to surround the discharge port 55 on the outer peripheral surface (outer peripheral portion) of the main body portion 531.

The attachment portion 57 in the first exemplary embodiment is configured as a structural portion to which the opening and closing portion 56 is attached to be movable in directions indicated by the arrows E1 and E2 along the mounting direction D1.

The direction indicated by the arrow E1 is a movement direction when the opening and closing portion 56 opens the discharge port 55 with respect to the attachment portion 57. In addition, the direction indicated by the arrow E1 corresponds to a direction opposite to the mounting direction D1. On the other hand, the direction indicated by the arrow E2 is a movement direction when the opening and closing portion 56 closes the discharge port 55 with respect to the attachment portion 57.

In addition, as shown in FIG. 7A and the like, the attachment portion 57 has a plate-shaped attachment main body 571 having a rectangular shape surrounding the discharge port 55, and the side wall portions 572 that hang downward from both end portions of the attachment main body 571 along the opening and closing directions E1 and E2 of the opening and closing portion 56.

The attachment main body 571 is provided in a state of protruding outward from a lower outer peripheral surface of the cylindrical main body portion 531 of the end portion holding body 53. A surface of the attachment main body 571 to which the opening and closing portion 56 is attached is formed as a substantially flat surface portion that surrounds the discharge port 55 except for an opening portion corresponding to the discharge port 55 (see FIG. 7B).

As shown in FIG. 5 and the like, the opening and closing portion 56 is attached in a state where the side wall portion 561b thereof is movably caught and held by the side wall portion 572 of the attachment portion 57.

In addition, as shown in FIG. 5 and the like, the end portion holding body 53 is provided with a depressed portion 534 that is depressed inwardly in a portion of the cylindrical main body portion 531 that is located in an upper section of the second internal space S2.

A storage medium 59 that stores information regarding the developer container 5 is disposed in the depressed portion 534. In a case where the developer container 5 is mounted in the mounting portion 15, the storage medium 59 is electrically connected to a connection terminal (not shown) provided on the mounting portion 15 side to read and write the information.

In the first exemplary embodiment, the depressed portion 534 has a structure in which a lower surface thereof is held from below as both end portions of the opening in the covering portion 533 of the shaft coupling 58 on the driven side are connected to the lower surface (see FIG. 7 and the like).

In addition, as shown in FIGS. 4, 5, and the like, the end portion holding body 53 is provided with a rotation holding portion 537 in an outer peripheral portion of the cylindrical main body portion 531 that is located in an upper section of the first internal space S1.

The rotation holding portion 537 is a portion that rotatably holds the agitating body 54.

A plurality of the rotation holding portions 537 in the first exemplary embodiment are provided in the main body portion 531 at intervals in a circumferential direction of the outer peripheral portion that is located in the upper section of the first internal space S1. In addition, the rotation holding portion 537 is provided as a projection portion having a shape protruding toward the first internal space S1 in an outer peripheral portion thereof.

In addition, as shown in FIGS. 5, 7, and the like, the end portion holding body 53 is provided with a cutout portion 535 in a portion of the main body portion 531 that is located in a lower section of the second internal space S2.

The cutout portion 535 is a portion cut out so as to enter the corresponding portion of the main body portion 531 on a side (inside) opposite to the mounting direction D1.

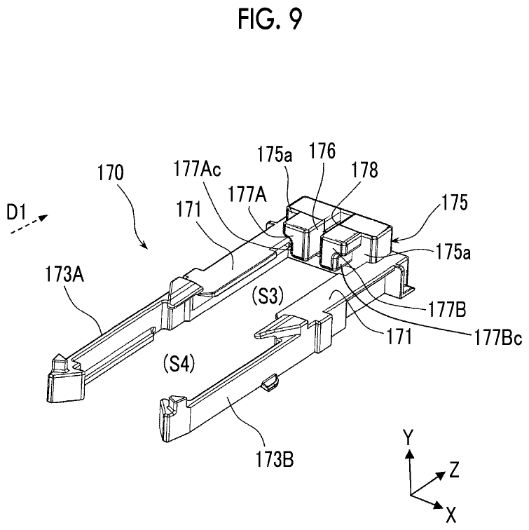

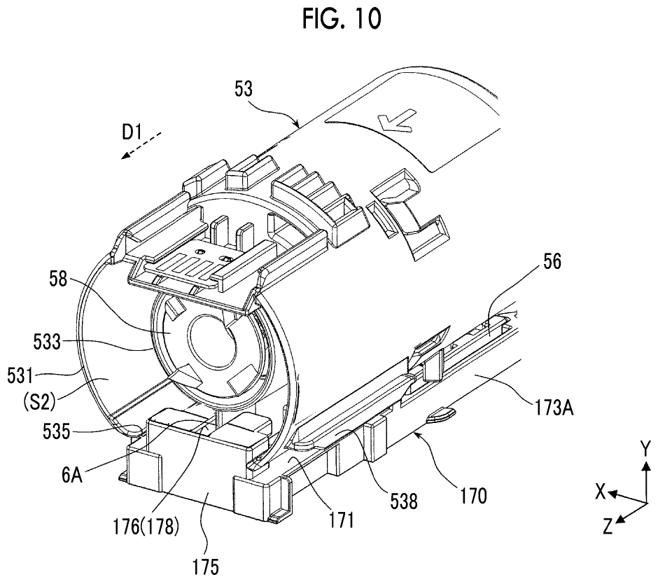

When the developer container 5 is mounted in the mounting portion 15, the cutout portion 535 is formed such that a mounting fitting portion 175, which will be described later, is fitted into a depressed edge portion of the cutout portion 535 (see FIGS. 9 and 10).

In addition, as shown in FIG. 7 and the like, the end portion holding body 53 is provided with a pair of guide receiving portions 538 and 539 on the outer peripheral portion of the main body portion 531.

The guide receiving portions 538 and 539 are portions that are guided by being placed on a pair of guide portions 162 and 163, which will be described later, in the mounting platform 16 of the mounting portion 15, during insertion and removal operations when the developer container 5 is attached to and detached from the mounting portion 15.

Furthermore, as shown in FIGS. 5, 6, and the like, the end portion holding body 53 is provided with an identification shape portion 70 in the outer peripheral portion of the cylindrical main body portion 531 that is located in the upper section of the first internal space S1.

The identification shape portion 70 is a portion formed as an identification shape to distinguish whether or not the developer container 5 can be mounted according to differences in types of the developer and the accommodation portion 51. The identification shape portion 70 is also referred to as, for example, a mechanical key.

The identification shape portion 70 in the first exemplary embodiment is a portion in which identification projection portions 71 and identification recess portions 72 are combined on the outer peripheral portion of the main body portion 531 in the circumferential direction. The identification projection portion 71 and the identification recess portion 72 are formed as a projection portion and a recess portion having predetermined lengths in the circumferential direction. The identification recess portion 72 is also a portion formed between the plurality of identification projection portions 71.

The identification shape portion 70 is formed to have a different uneven pattern corresponding to the difference in the type of the developer or the type of the accommodation portion 51. Therefore, the identification shape portions 70 in the developer containers 5A, 5B, 5C, and 5D are formed in different uneven patterns, for example, due to the difference in the type of the developer.

### Agitating Body

The agitating body 54 is a structure attached to the open end portion 52a of the accommodation main body 52.

In addition, the agitating body 54 is a structure having a function of agitating the developer G (toner T) that moves from an inside of the accommodation main body 52 is discharged through the open end portion 52a.

As shown in FIGS. 4 and 6, and the like, the agitating body 54 in the first exemplary embodiment has a cylindrical main body portion 541 of which both end portions 541a and 541b are open.

As shown in FIG. 6 and the like, the main body portion 541 is configured so that an entire portion including a shaft fitting portion 545 and an agitating portion 546, which will be described later, is accommodated in the first internal space S1 of the end portion holding body 53.

In addition, as shown in FIG. 6 and the like, the main body portion 541 is configured so that the coupled portion 523 of the accommodation main body 52 is fitted into an internal space of the end portion 541b on the upstream side in the mounting direction D1. An inner wall of the end portion 541b of the main body portion 541 on the upstream side is formed with a coupling portion 543 (see FIG. 6) to be coupled to the coupled portion 523 of the accommodation main body 52.

Furthermore, the main body portion 541 is provided with an annular flange portion 544 that continuously protrudes in the circumferential direction on an outer peripheral portion of the end portion 541a on the downstream side in the mounting direction D1. The flange portion 544 is rotatably held by the rotation holding portion 537 of the end portion holding body 53 when the main body portion 541 is fitted into the first internal space S1 of the end portion holding body 53 (see FIG. 7 and the like).

In addition, as shown in FIGS. 4, 6, and the like, the agitating body 54 is provided with the shaft fitting portion 545 at the end portion 541a of the main body portion 541 on the downstream side in the mounting direction D1.

The shaft fitting portion 545 is formed as a cylindrical structural portion that protrudes in the mounting direction D1 from a central portion of a support plate that is fixed to extend inside the opening of the end portion 541a in a diameter direction thereof. As shown in FIG. 6, the shaft fitting portion 545 is provided with a fitting hole 545a into which the transmission shaft portion 582 of the shaft coupling 58 on the driven side is fitted and fixed, at a center portion thereof.

Furthermore, as shown in FIGS. 4, 6, and the like, the agitating body 54 is provided with the agitating portion 546 at the end portion 541a of the main body portion 541 on the downstream side in the mounting direction D1.

The agitating portion 546 is formed as two rod-shaped structural portions protruding in the mounting direction D1 from both side portions of the support plate with the shaft fitting portion 545 interposed therebetween.

All of the developer containers 5A, 5B, 5C, and 5D have a structure formed by assembling the accommodation portion 51 in which the portion to which the agitating body 54 of the accommodation main body 52 is attached is rotatably held by the end portion holding body 53.

Mounting platform of Mounting Portion

As shown in FIG. 8, the respective mounting platforms 16 in the mounting portions 15A, 15B, 15C, and 15D have plate-shaped holding platforms 161 elongated in one direction to respectively hold lower portions of the developer containers 5A, 5B, 5C, and 5D.

The holding platform 161 is provided with side walls that rise upward at both end portions along a longitudinal direction thereof. Upper ends of the side walls are formed as guide portions 162 and 163. The guide portions 162 and 163 are portions that guide the developer containers 5A, 5B, 5C, and 5D along the mounting direction D1 and the detachment direction D2 during the insertion and removal for the attachment and detachment, respectively, and rotatably hold the accommodation main body 52 of the accommodation portion 51.

The holding platform 161 is provided with a termination wall 164 at an end portion in the mounting direction D1.

A holding recess portion 164a that introduces and holds the covering portion 533 of the end portion holding body 53 of the developer containers 5A, 5B, 5C, and 5D is provided on an upper portion of the termination wall 164. The holding recess portion 164a is formed as a portion having a shape depressed in an arc shape.

In addition, the holding platform 161 is provided with a passage port 165 through which the developer passes in a portion of a bottom surface portion thereof on an inner side in the mounting direction D1. The passage port 165 is provided at a position facing the discharge port 55 of each of the mounted developer containers 5A, 5B, 5C, and 5D.

Furthermore, the holding platform 161 is provided with an opening and closing guide body 170 in a portion on the inner side in the mounting direction D1 to surround the passage port 165 in the bottom surface portion thereof.

The opening and closing guide body 170 includes a placing platform 171 for the attachment portion 57, an opening and closing portion holding portion 173 that holds the opening and closing portion 56, and a mounting fitting portion 175.

The placing platform 171 is formed as a pair of flat surface platforms parallel to each other along the mounting direction D1 at an interval to secure a facing space S3.

The facing space S3 is a space facing the discharge port 55 in the developer containers 5A, 5B, 5C, and 5D and the passage port 165 in the holding platform 161. On the placing platform 171, a portion of the attachment portion 57 in the developer containers 5A, 5B, 5C, and 5D that is not present when the opening and closing portion 56 is moved in a direction of opening the discharge port 55 is placed.

The opening and closing portion holding portion 173 is formed as a pair of holding arm portions 173A and 173B that are parallel to each other along the mounting direction D1 at an interval to secure a holding space S4.

The holding space S4 is a space for holding the opening and closing portions 56 in the developer containers 5A, 5B, 5C, and 5D from both sides along the mounting direction D1 when the opening and closing portion 56 is mounted. The opening and closing portion holding portion 173 holds and stops the opening and closing portion 56 in the middle of the mounting of the opening and closing portion 56, and moves the opening and closing portion 56 in the movement direction E1 when the opening and closing portion 56 is opened with respect to the attachment portion 57.

The mounting fitting portion 175 is a portion that is fitted into the cutout portion 535 of the end portion holding body 53 of the developer container 5 when the developer container 5 is mounted in the mounting portion 15 (see FIGS. 9 and 10).

The mounting fitting portion 175 also serves as a portion that connects and holds the pair of flat surface platforms of the placing platform 171.

### Mounting of Developer Container in Mounting Portion

In a case where the developer containers 5A, 5B, 5C, and 5D are respectively mounted in the mounting portions 15A, 15B, 15C, and 15D, the developer containers 5A, 5B, 5C, and 5D are guided in the mounting direction D1 by the guide portions 162 and 163 of the holding platform 161 and are pushed into the respective storage spaces.

In addition, during the pushing of the developer containers 5A, 5B, 5C, and 5D, the opening and closing portion 56 is held and stopped by the opening and closing portion holding portion 173 of the opening and closing guide body 170, and then the opening and closing portion 56 is moved in the movement direction E1 when the opening and closing portion 56 is opened with respect to the attachment portion 57.

Subsequently, the developer containers 5A, 5B, 5C, and 5D enter a state where the mounting fitting portion 175 of the opening and closing guide body 170 is fitted into the cutout portion 535 of the end portion holding body 53.

Accordingly, the mounting of the developer containers 5A, 5B, 5C, and 5D in the respective mounting portions 15A, 15B, 15C, and 15D is completed.

In a process of completing the mounting of the developer containers 5A, 5B, 5C, and 5D, the opening and closing portion 56 is moved in the movement direction E1 in which the opening and closing portion 56 is opened to open the discharge port 55. In this case, the discharge port 55 enters a state of facing and being continuous with the passage port 165 of the mounting platform 16 through the facing space S3.

In addition, the shaft coupling 58 on the driven side in the developer containers 5A, 5B, 5C, and 5D is connected to the shaft coupling 19 on the drive side in the mounting portions 15A, 15B, 15C, and 15D. Accordingly, in a case where the rotational power is transmitted to the shaft coupling 58 on the driven side, the developer containers 5A, 5B, 5C, and 5D are rotated in the direction of the arrow M in a state where the accommodation main body 52 and the agitating body 54 included in the accommodation portion 51 are held by the end portion holding body 53.

In a process of mounting the developer containers 5A, 5B, 5C, and 5D, the identification shape portion 70 distinguishes whether or not the developer containers 5A, 5B, 5C, and 5D can be mounted with an identification matching portion (not shown) provided at each of corresponding positions of the storage spaces of the mounting portions 15A, 15B, 15C, and 15D.

In this case, the developer containers 5A, 5B, 5C, and 5D can be mounted in the mounting portions 15 only in a case where the identification shape portion 70 matches the identification matching portion. In contrast, in a case where the identification shape portion 70 does not match the identification matching portion and is inconsistent, the developer containers 5A, 5B, 5C, and 5D cannot be mounted in the mounting portion 15, and erroneous mounting is prevented.

When it is time to replenish the developer, the developer containers 5A, 5B, 5C, 5D, which have been mounted, are rotated by a predetermined amount in the direction of the arrow M in a state where the accommodation main body 52 and the agitating body 54 are held by the end portion holding body 53.

Accordingly, the developer G (toner T) accommodated in the accommodation main body 52 is transported to be moved to an agitating body 54 side by the helical ridge portion 525 of the rotating accommodation main body 52. Subsequently, the developer G (toner T) transported in advance is sequentially discharged and falls from the discharge port 55 provided in a lower portion of the end portion holding body 53. In a case where the developer G (toner T) passes through the agitating body 54, the developer G is agitated and broken up by the agitating portion 546.

The developer G (toner T) discharged from the discharge port 55 passes through the passage port 165 in the mounting portions 15A, 15B, 15C, and 15D and is sent to the replenishing device 17.

### Further Configuration of Developer Container and the Like

In the developer containers 5A, 5B, 5C, and 5D, from the viewpoint of securing sealability of the discharge port 55 by the opening and closing portion 56 of the attachment portion 57, a plate-shaped extending portion 575 that extends from the attachment main body 571 toward the downstream side in the mounting direction D1 is provided.

The extending portion 575 is an extension of an end portion of the plate-shaped attachment main body 571 on the downstream side in the mounting direction D1 away from the discharge port 55 toward the downstream side in the mounting direction D1.

By providing the extending portion 575 in the attachment portion 57, a planar surface of the attachment main body 571 on which the opening and closing portion 56 is present is extended to be wide toward the downstream side of the discharge port 55 in the mounting direction D1. That is, regarding the attachment portion 57, the attachment main body 571 has a wider flat surface portion.

As a result, as shown in FIG. 7A and the like, when the opening and closing portion 56 enters a state of closing the discharge port 55, the attachment portion 57 can be brought into a state of facing the opening and closing portion 56 with a large margin to the extending portion 575 of the attachment main body 571.

Accordingly, as shown in FIG. 7A and the like, the opening and closing portion 56 in the first exemplary embodiment can particularly bring the protruding portion 563c of the peripheral sealing sheet 563 into wide contact with the flat surface portion of the extending portion 575, thereby improving the sealability of the discharge port 55.

In addition, as shown in FIGS. 5, 7, and the like, in the developer containers 5A, 5B, 5C, and 5D, three support portions 6 that support the extending portion 575 are provided on an extending surface of the extending portion 575 of the attachment portion 57 on a side opposite to the opening and closing portion 56.

The three support portions 6 include a first support portion 6A, a second support portion 6B, and a third support portion 6C.

The first support portion 6A is provided at a substantially central portion in a width direction perpendicular to the mounting direction D1 on the surface of the extending portion 575 on the opposite side.

In addition, the first support portion 6A is formed as a plate-shaped portion 60 (see FIG. 5) that is substantially orthogonal to the surface of the extending portion 575 on the opposite side.

In addition, the first support portion 6A is provided in a form in which the plate-shaped portion 60 is connected and fixed to the partition wall 532 of the end portion holding body 53.

Furthermore, the first support portion 6A is provided in a form connected to the covering portion 533 of the end portion holding body 53, which is an example of an opposing structural portion having a portion facing the extending portion 575.

Specifically, the first support portion 6A is connected to abut against a curved surface of a lower portion of the covering portion 533 curved in an arc shape.

The second support portion 6B and the third support portion 6C are respectively provided in portions slightly inner than both end portions in the width direction orthogonal to the mounting direction D1 on the surface of the extending portion 575 on the opposite side. In other words, the second support portion 6B and the third support portion 6C are provided to be present at positions at an interval on both sides of the first support portion 6A with the first support portion 6A interposed therebetween.

In addition, the second support portion 6B and the third support portion 6C are formed as plate-shaped portions (see FIG. 5) substantially orthogonal to the surface of the extending portion 575 on the opposite side, similarly to the first support portion 6A.

Furthermore, the second support portion 6B and the third support portion 6C are provided in a form in which one end portion (upper end portion) thereof is connected to a part of the end portion holding body 53, which is the opposing structural portion.

Specifically, the second support portion 6B and the third support portion 6C are connected to abut against a curved surface portion of a lower portion on an inner side of the cutout portion 535 of the end portion holding body 53.

Therefore, according to the developer containers 5A, 5B, 5C, and 5D, regarding the extending portion 575, compared to a case where the extending portion 575 is not provided with the support portion 6 that supports the extending portion 575, the extending portion 575 can become a portion that is less likely to be deformed or damaged by providing the flat surface portion that is made wider to secure the sealability of the discharge port 55 by the opening and closing portion 56.

In addition, in the developer containers 5A, 5B, 5C, and 5D according to the first exemplary embodiment, three support portions 6, that is, the first support portion 6A, the second support portion 6B, and the third support portion 6C are provided as the support portion 6.

Therefore, regarding the extending portion 575, compared to a case where one support portion or two support portions are provided as the support portion 6, the extending portion 575 can become a portion that is less likely to be deformed or damaged by providing the flat surface portion that is made even wider in the opening and closing portion 56.

Incidentally, regarding the extending portion 575, for example, it is also considered to increase a thickness of the extending portion 575 instead of providing the support portion 6.

However, in this case, when the extending portion 575 is produced by a plastic molding method, depression-like deformation (sink mark) may occur due to molding, and a smooth surface of a surface to which the opening and closing portion 56 is attached may not be obtained. In this case, the sealability in the extending portion 575 of the attachment portion 57 deteriorates, and leakage of the developer may be incurred.

In this regard, in the extending portion 575 on which the support portion 6 is provided, the extending portion 575 is less likely to be deformed due to sink marks or the like.

In addition, when the developer containers 5A, 5B, 5C, and 5D are mounted in the mounting portion 15 or handled by holding the grip portion 527 and the like by hand, the user may cause a lower portion of a front end in the mounting direction D1 to be brought into contact with a surrounding portion of the mounting portion 15 or to be dropped and hit by an object present at a place where the lower portion of the front end is dropped.

That is, in a case of handling the developer containers 5A, 5B, 5C, and 5D, the developer containers 5A, 5B, 5C, and 5D may be erroneously operated by the user as described above.

Incidentally, in the developer containers 5A, 5B, 5C, and 5D, there may be a case where the developer G is unevenly present on one end portion side of either of both ends in the longitudinal direction, and a case where an overall weight balance becomes uneven due to the reason that the developer containers 5A, 5B, 5C, and 5D have the container structure having the end portion holding body 53.

Therefore, the front end of the developer containers 5A, 5B, 5C, and 5D in the mounting direction D1 or a rear end opposite to the front end tends to be directed downward, and a probability of falling from the front end or the rear end increases. This may easily induce erroneous operation by the user mentioned above.

In a case where an erroneous operation or the like by the user occurs, the extending portion 575 that is present to extend on the front end side of the mounting direction D1 of the developer containers 5A, 5B, 5C, and 5D is more likely to come into contact with or collide with another object, increasing a probability of damage.

In this regard, in the extending portion 575 provided with the first support portion 6A, the second support portion 6B, and the third support portion 6C, strength of the extending portion 575 is increased by each of the support portions 6A, 6B, and 6C, and thus the extending portion 575 is less likely to be damaged.

In addition, in the developer containers 5A, 5B, 5C, and 5D, the first support portion 6A is provided in a form connected to the covering portion 533, and the second support portion 6B and the third support portion 6C are provided in a form connected to a part of the end portion holding body 53.

Therefore, according to the developer containers 5A, 5B, 5C, and 5D, compared to a case where the first support portion 6A, the second support portion 6B, and the third support portion 6C are provided in a form not connected to the covering portion 533 or the part of the end portion holding body 53, the strength of the extending portion 575 is further increased by each of the support portions 6A, 6B, and 6C.

Accordingly, the extending portion 575 is less likely to be deformed or damaged.

In addition, compared to a case where the connection is not provided, it is more difficult for a user's finger or the like to enter a gap between the extending portion 575 and the covering portion 533 or a gap between the extending portion 575 and the part of the end portion holding body 53. In short, the presence of any one of the support portions 6A, 6B, and 6C in a part of each of the gaps may prevent entrance of the user's finger or the like.

Moreover, a probability of the occurrence of deformation of the extending portion 575 and deformation of the covering portion 533 or the part of the end portion holding body 53 to which the support portion 6 is connected in a case where the user's finger or the like enters each of the gaps is avoided or reduced.

In addition, in the developer containers 5A, 5B, 5C, and 5D, as shown in FIG. 5 and the like, the first support portion 6A is connected to a portion of an arcuate curved surface shape that is convex downward in the covering portion 533, which is the example of the opposing structural portion.

Therefore, according to the developer containers 5A, 5B, 5C, and 5D, compared to a case where the first support portion 6A is connected to a flat surface-shaped portion in the opposing structural portion, even in a case where an external force F such as an impact or vibration is applied to the extending portion 575 through the plate-shaped portion 60 of the first support portion 6A, the external force F is easily distributed and transmitted as, for example, forces fa and fb in a curved surface-shaped portion of the covering portion 533 (see FIG. 5). Accordingly, the extending portion 575 is less likely to be deformed or damaged.

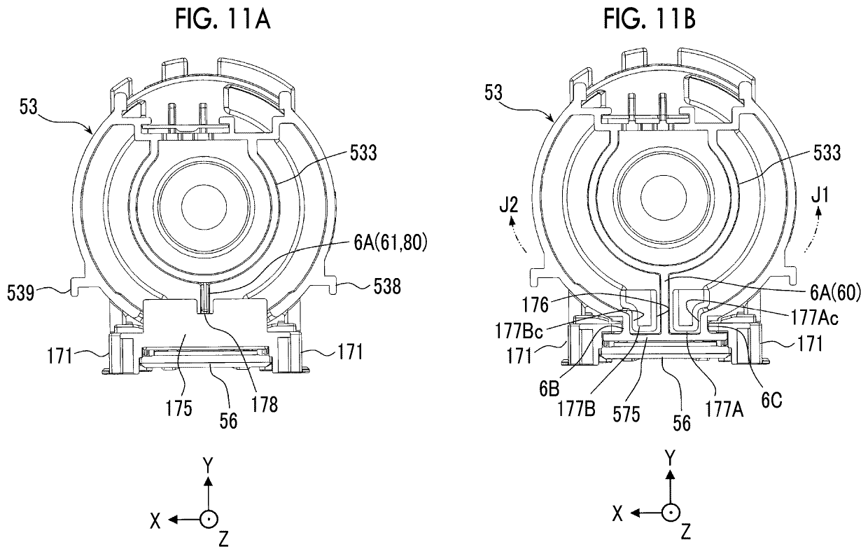

Next, in the exemplary embodiment, as shown in FIGS. 10 and 11, the first support portion 6A is configured as a portion that is fitted into a recess portion 176 in the mounting portion 15.

Specifically, at least the plate-shaped portion 60 of the first support portion 6A is fitted into the recess portion 176.

In this case, as shown in FIG. 9 and the like, in the mounting portions 15A, 15B, 15C, and 15D, the recess portion 176 is provided in the mounting fitting portion 175 of the opening and closing guide body 170.

The recess portion 176 is formed by disposing a pair of projection portions 177A and 177B, which protrude from a side surface 175a of the mounting fitting portion 175 facing the developer container 5 to be mounted toward the side opposite to the mounting direction D1, at a predetermined interval. A groove width of the recess portion 176 is set to be slightly larger than a thickness of the plate-shaped portion 60 of the first support portion 6A.

When the developer containers 5A, 5B, 5C, and 5D are mounted in the mounting portions 15A, 15B, 15C, and 15D, as shown in FIGS. 10 and 11B, the plate-shaped portion 60 of the first support portion 6A enters a state of being fitted into the recess portion 176 of the mounting fitting portion 175.

Therefore, according to the developer containers 5A, 5B, 5C, and 5D, compared to a case where the plate-shaped first support portion 6A is not configured as a portion that is fitted into the recess portion 176 provided in the mounting portion 15 as a mounting destination during the mounting, the plate-shaped first support portion 6A is kept in a state where the plate-shaped first support portion 6A is less likely to move due to the recess portion 176.

Here, in a stage of mounting the developer container 5 in the mounting portion 15 or after the mounting, the accommodation portion 51 (the accommodation main body 52 or the like) of the developer container 5 may be subjected to an unexpected movement due to an unnecessary operation of the user or to vibration caused by an operation of the developer container 5 or the like. Arrows J1 and J2 in FIG. 11B indicate directions in which the end portion holding body 53 may move when subjected to a movement that causes rotation due to an unnecessary operation by the user.

That is, even at such times, as long as the developer containers 5A, 5B, 5C, and 5D are used, even in a case where the developer containers 5A, 5B, 5C, and 5D are subjected to external forces due to the movement and vibration, the plate-shaped first support portion 6A is kept in a state where the plate-shaped first support portion 6A is less likely to move due to the recess portion 176. Therefore, the unnecessary external forces are less likely to be applied to the extending portion 575 through the plate-shaped first support portion 6A. As a result, the extending portion 575 is less likely to be deformed or damaged.

Next, in the exemplary embodiment, as shown in FIG. 5 and the like, the first support portion 6A is provided with a protruding portion 61 that protrudes toward the front end side with respect to an end portion 575a (see FIG. 7B and the like) of the extending portion 575b on the front end side in the mounting direction D1.

The protruding portion 61 in the first exemplary embodiment is provided in a plate-shaped form that protrudes toward the downstream side in the mounting direction D1 from an upper portion of the plate-shaped portion 60 of the first support portion 6A. In addition, the protruding portion 61 is provided in a state where the upper portion thereof is connected to the covering portion 533.

Therefore, according to the developer containers 5A, 5B, 5C, and 5D, compared to a case where the protruding portion 61 is not provided in the first support portion 6A, even in a case where the extending portion 575 is subjected to an impact from the outside in the event of a fall, collision, or the like, the impact is more likely to be received by the protruding portion 61 of the first support portion 6A than by the extending portion 575. As a result, a situation in which the extending portion 575 is subjected to the impact from the outside first can be reduced. Accordingly, the extending portion 575 is less likely to be deformed or damaged.

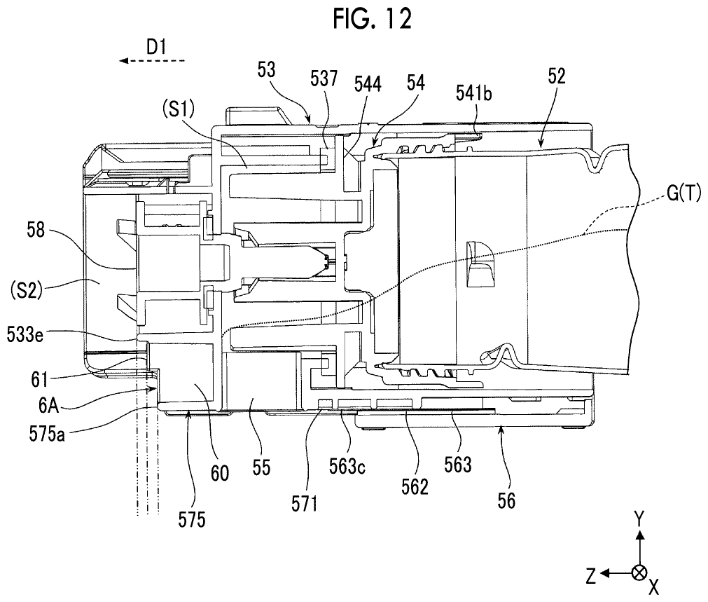

Moreover, as shown in FIG. 12 and the like, the protruding portion 61 of the first support portion 6A in the first exemplary embodiment is provided in a form that is present on the upstream side in the mounting direction D1 with respect to an end portion 533e of a portion of the covering portion 533 facing the first support portion 6A on the downstream side in the mounting direction D1.

The protruding portion 61 at this time is provided in a form that protrudes toward the downstream side in the mounting direction D1 with respect to the end portion 575a of the extending portion 575 on the downstream side in the mounting direction D1.

Therefore, according to the developer containers 5A, 5B, 5C, and 5D, compared to a case where the protruding portion 61 of the first support portion 6A is provided in a form that protrudes toward the downstream side in the mounting direction D1 with respect to the end portion 533e of the covering portion 533, a situation in which the protruding portion 61 is subjected to an unnecessary collision or impact from the downstream side in the mounting direction D1 before the end portion 533e of the covering portion 533 can be suppressed.

Accordingly, the extending portion 575 is less likely to be deformed or damaged.

In addition, the protruding portion 61 of the first support portion 6A is provided on an upper portion side of the plate-shaped portion 60. In other words, the protruding portion 61 is provided at a portion away from the discharge port 55 compared to a case where the protruding portion 61 is provided on a lower portion side of the plate-shaped portion 60.

Therefore, even when the developer containers 5A, 5B, 5C, and 5D fall or the like due to an erroneous operation of the user, a probability that the protruding portion 61 of the first support portion 6A is subjected to an impact (external force F) is higher than that in a case where the protruding portion 61 is provided on the lower portion side of the plate-shaped portion 60.

Accordingly, in the developer containers 5A, 5B, 5C, and 5D, even in a case where the developer containers 5A, 5B, 5C, and 5D fall or the like, the extending portion 575 and other portions (the discharge port 55 and the like) of the attachment portion 57 are less likely to be deformed or damaged.

In the exemplary embodiment, the first support portion 6A can be configured to be used as an identification shape portion 80.

As in the case of the identification shape portion 70, the identification shape portion 80 in this case is a portion having a shape to distinguish whether or not the developer container 5 can be mounted in the mounting portion 15 according to a difference in the type of the developer G or a difference in the type of the accommodation portion 51.

The identification shape portion 80 of the first support portion 6A is configured with, for example, a positional relationship or a dimensional difference between the plate-shaped portion 60 and the protruding portion 61 in the first support portion 6A, or a projection portion or a recess portion provided in each of the plate-shaped portion 60 and the protruding portion 61.

In the first support portion 6A according to the first exemplary embodiment, the protruding portion 61 is used as the identification shape portion 80, and the mounting portion 15 is provided with a matching recess portion 178 as an example of a matching shape portion into which the protruding portion 61 is fitted as shown in FIG. 11A. As shown in FIGS. 9, 11A, and the like, the matching recess portion 178 is formed by providing a predetermined gap in a substantially central portion of the mounting fitting portion 175.

In this case, different types of the developer containers 5 may be accommodated in a manner in which the protruding portions 61 having different shapes are provided in the first support portions 6A, while the mounting portions 15 corresponding to the developer containers 5 are either configured without the matching recess portion 178 or provided with matching recess portions having shapes that match the protruding portions 61 having different shapes.

Therefore, according to the developer containers 5A, 5B, 5C, and 5D, compared to a case where the first support portion 6A is not configured to be used as the identification shape portion 80, the first support portion 6A can also be used as a portion having a function of distinguishing whether or not the developer container 5 can be mounted in the mounting portion 15 according to differences in the types of the developer G and the accommodation portion 51. That is, the first support portion 6A can be effectively used.

In addition, according to the developer containers 5A, 5B, 5C, and 5D, even in a case where the number of types of the developer and the accommodation portion is increased and it is difficult to cope with the increase with only the above-described identification shape portion 70, the first support portion 6A is configured to be used as the identification shape portion 80, whereby it is possible to secure a function of distinguishing whether or not the various types of developer containers 5 can be mounted in the mounting portion 15.

Furthermore, in the developer containers 5A, 5B, 5C, and 5D, as shown in FIG. 11B, the second support portion 6B and the third support portion 6C present on both sides of the first support portion 6A are configured to be respectively fitted into fitting recess portions 177Ac and 177Bc of one side surface portions of the pair of projection portions 177A and 177B in the opening and closing guide body 170.

Even with this, during the mounting, the developer containers 5A, 5B, 5C, and 5D are kept from moving easily by the fitting between the second support portion 6B and the third support portion 6C and the fitting recess portions 177Ac and 177Bc.

Incidentally, the second support portion 6B and the third support portion 6C may also be configured as a part of the identification shape portion 80.

### Modification Example

The present invention is not limited to the configuration described as the first exemplary embodiment, and various modifications or improvements can be made without changing the gist of each invention described in the claims. Therefore, the present invention also includes, for example, the following modification examples.

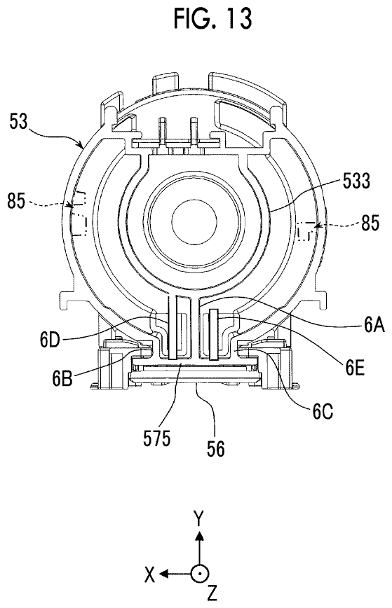

As shown in FIG. 13, in the developer container 5 according to the exemplary embodiment of the present invention, as the support portion 6, two support portions, a fourth support portions 6D and a fifth support portion 6E may be provided at an interval in the width direction of the extending portion 575.

The fourth support portion 6D is a support portion provided in a state of being connected to the covering portion 533, similarly to the case of the first support portion 6A. The fifth support portion 6E is a support portion provided in a state of not being connected to the covering portion 533. Both the fourth support portion 6D and the fifth support portion 6E are provided in a state of being connected to the partition wall 532 of the end portion holding body 53.

In a case where the fourth support portion 6D and the fifth support portion 6E are provided as described above, each of the support portions 6D and 6E may be configured as a different type of identification shape portion 80. In this case, the mounting portion 15 is also provided with a matching shape portion such as a recess portion that has a shape that matches the different type of identification shape portion 80 in each of the support portions 6D and 6E and enables the mounting of the accommodation portion 51 of the developer container 5.

In such a case, even in a case where the number of types of the developer or types of the accommodation portion 51 of the developer container 5 is further increased, it is possible to prevent the occurrence of erroneous mounting of the developer container 5 in the mounting portion 15.

In addition, as shown by a two-dot chain line in FIG. 13, the developer container 5 in the exemplary embodiment of the present invention may be provided with an additional identification shape portion 85 at an inner part of the end portion holding body 53 of the accommodation portion 51 on the front end side in the mounting direction D1. In this case, the mounting portion 15 is also provided with a matching shape portion such as a recess portion that has a shape that matches the additional identification shape portion 85 and enables the mounting of the accommodation portion 51 of the developer container 5.

With this configuration, even though the number of types of the developer or types of the accommodation portion 51 of the developer container 5 is further increased, it is possible to prevent the occurrence of erroneous mounting of the developer container 5 in the mounting portion 15.

The support portion 6 in the developer container 5 in the exemplary embodiment of the present invention is not limited to a plate-shaped form, and may be a form consisting of a shape other than the plate shape as long as at least the extending portion 575 can be supported. In a case where a plurality of support portions 6 are provided, the number thereof is not limited to three, and may be, for example, two or four.

In addition, the support portion 6 may be provided to be connected to a two-surface shape (for example, a two-surface shape that is developed in a V shape) that is developed such that the portion of the opposing structural portion facing the extending portion 575 crosses diagonally.

The number of support portions 6 is not particularly limited, and may be, for example, one or two.

The accommodation portion 51 of the developer container 5 in the exemplary embodiment of the present invention is not limited to a rotary type accommodation portion in which the accommodation main body 52 and the like shown in the first exemplary embodiment are rotatably held by the end portion holding body 53. As another type of accommodation portion 51, for example, a fixed type accommodation portion may be disposed in which the accommodation portion 51 itself does not rotate and a transport member that rotates and transports the developer inside the accommodation portion 51.

Even in the case of the fixed type accommodation portion 51, in a case where a plate-shaped extending portion that extends toward the front end side in the mounting direction D1 is provided in the attachment portion 57 of the opening and closing portion 56, for example, the support portion 6 may be provided.

In addition, the opening and closing portion 56 of the developer container 5 in the exemplary embodiment of the present invention may be an opening and closing portion that opens and closes the discharge port 55 by moving along an outer circumference of the cylindrical accommodation portion 51 of the fixed type in the circumferential direction. Even in this case, in a case where a plate-shaped extending portion that extends toward the front end side in the mounting direction D1 is provided in the attachment portion 57 of the opening and closing portion 56, for example, the support portion 6 may be provided.

Incidentally, in this case, a surface of a support body to which the opening and closing portion 56 of the attachment portion 57 is attached is a curved surface portion that is curved in an arc shape.

Furthermore, the image forming apparatus 1 using the developer container 5 in the exemplary embodiment of the present invention is not particularly limited to the number of developer containers 5 used, the number of colors in images, the configuration of the image forming section 20, and the like.

### Supplementary Notes

(((1)))

A developer container comprising:

an accommodation portion that accommodates a developer;

a discharge port through which the developer is discharged from an outer peripheral portion of the accommodation portion on a front end side in a mounting direction;

an opening and closing portion that opens and closes the discharge port from an outside; and

an attachment portion that surrounds the discharge port and to which the opening and closing portion is movably attached,

wherein the attachment portion has an extending portion extending toward the front end side in the mounting direction, and

the extending portion is provided with a support portion that supports the extending portion on a surface opposite to the opening and closing portion.

(((2)))

The developer container according to (((1))),

wherein the accommodation portion includes an opposing structural portion having a portion facing the extending portion at an inner part on the front end side in the mounting direction, and

the support portion is provided in a form connected to the opposing structural portion.

(((3)))

The developer container according to (((1))) or (((2))),

wherein the support portion has a protruding portion that protrudes toward the front end side with respect to an end portion of the extending portion on the front end side in the mounting direction.

(((4)))

The developer container according to any one of (((1))) to (((3)))),

wherein the support portion is provided with an identification shape portion for distinguishing whether or not the developer container can be mounted according to differences in types of the developer and the accommodation portion.

(((5)))

The developer container according to (((2))),

wherein the support portion has a plate shape, and

the plate-shaped support portion is configured as a portion that is fitted into a recess portion of a mounting destination when the accommodation portion is mounted.

(((6)))

The developer container according to (((2))),

wherein the support portion has a plate shape, and

the facing portion of the opposing structural portion has a curved surface shape of

which a projection side is connected to the plate-shaped support portion or has a two-surface shape that is developed to cross diagonally.

(((7)))

The developer container according to (((3))),

wherein the accommodation portion includes an opposing structural portion having a portion facing the extending portion at an inner part on the front end side in the mounting direction, and

the protruding portion is provided in a form that is present on an upstream side in the mounting direction with respect to an end portion of the facing portion on a downstream side in the mounting direction.

(((8)))

The developer container according to (((4))),

wherein the support portion is provided as a plurality of support portions at intervals, and

the identification shape portion is provided in each of the plurality of support portions.

(((9)))

The developer container according to any one of (((1))) to (((8))),

wherein the accommodation portion is provided with an additional identification shape portion for distinguishing whether or not the developer container can be mounted according to differences in types of the developer and the accommodation portion at an inner part on the front end side in the mounting direction.

(((10)))

An image forming apparatus comprising:

an image forming section that forms an image consisting of a developer; and a developer container that accommodates the developer supplied to the image forming section; and

a mounting portion in which the developer container is attachably and detachably mounted by inserting and removing the developer container,

wherein the developer container is the developer container according to any one of (((1))) to (((9))).

(((11)))

The image forming apparatus according to (((10))),

wherein the mounting portion is provided with a recess portion into which a support portion is fitted.

(((12)))

The image forming apparatus according to (((10))),

wherein, in a case where the developer container is the developer container according to (((4))),

the mounting portion is provided with an identification matching portion that has a shape that matches the identification shape portion and enables mounting of the accommodation portion.

(((13)))

The image forming apparatus according to (((10))),

wherein, in a case where the developer container is the developer container according to (((8))),

the mounting portion is provided with a plurality of identification matching portions that have shapes that respectively match the identification shape portions of the plurality of support portions and enable mounting of the accommodation portion.

(((14)))

The image forming apparatus according to (((10))),

wherein, in a case where the developer container is the developer container according to (((9))),

the mounting portion is provided with an additional identification matching portion that has a shape that matches the identification shape portion and enables mounting of the accommodation portion.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developer container comprising:
an accommodation portion that accommodates a developer;
a discharge port through which the developer is discharged from an outer peripheral portion of the accommodation portion on a front end side in a mounting direction;
an opening and closing portion that opens and closes the discharge port from an outside; and
an attachment portion that surrounds the discharge port and to which the opening and closing portion is movably attached,
wherein the attachment portion has an extending portion extending toward the front end side in the mounting direction, and
the extending portion is provided with a support portion that supports the extending portion on a surface opposite to the opening and closing portion.

2. The developer container according to claim 1,
wherein the accommodation portion includes an opposing structural portion having a portion facing the extending portion at an inner part on the front end side in the mounting direction, and
the support portion is provided in a form connected to the opposing structural portion.

3. The developer container according to claim 1,
wherein the support portion has a protruding portion that protrudes toward the front end side with respect to an end portion of the extending portion on the front end side in the mounting direction.

4. The developer container according to claim 1,
wherein the support portion is provided with an identification shape portion for distinguishing whether or not the developer container can be mounted according to differences in types of the developer and the accommodation portion.

5. The developer container according to claim 2,
wherein the support portion has a plate shape, and
the plate-shaped support portion is configured as a portion that is fitted into a recess portion of a mounting destination when the accommodation portion is mounted.

6. The developer container according to claim 2,
wherein the support portion has a plate shape, and
the facing portion of the opposing structural portion has a curved surface shape of which a projection side is connected to the plate-shaped support portion or has a two-surface shape that is developed to cross diagonally.

7. The developer container according to claim 3,
wherein the accommodation portion includes an opposing structural portion having a portion facing the extending portion at an inner part on the front end side in the mounting direction, and
the protruding portion is provided in a form that is present on an upstream side in the mounting direction with respect to an end portion of the facing portion on a downstream side in the mounting direction.

8. The developer container according to claim 4,
wherein the support portion is provided as a plurality of support portions at intervals, and
the identification shape portion is provided in each of the plurality of support portions.

9. The developer container according to claim 1,
wherein the accommodation portion is provided with an additional identification shape portion for distinguishing whether or not the developer container can be mounted according to differences in types of the developer and the accommodation portion at an inner part on the front end side in the mounting direction.

10. An image forming apparatus comprising:
an image forming section that forms an image consisting of a developer; and
a developer container that accommodates the developer supplied to the image forming section; and
a mounting portion in which the developer container is attachably and detachably mounted by inserting and removing the developer container,
wherein the developer container is the developer container according to claim 1.

11. An image forming apparatus comprising:
an image forming section that forms an image consisting of a developer; and
a developer container that accommodates the developer supplied to the image forming section; and
a mounting portion in which the developer container is attachably and detachably mounted by inserting and removing the developer container,
wherein the developer container is the developer container according to claim 2.

12. An image forming apparatus comprising:
an image forming section that forms an image consisting of a developer; and
a developer container that accommodates the developer supplied to the image forming section; and
a mounting portion in which the developer container is attachably and detachably mounted by inserting and removing the developer container,
wherein the developer container is the developer container according to claim 3.

13. An image forming apparatus comprising:
an image forming section that forms an image consisting of a developer; and
a developer container that accommodates the developer supplied to the image forming section; and
a mounting portion in which the developer container is attachably and detachably mounted by inserting and removing the developer container,
wherein the developer container is the developer container according to claim 4.

14. An image forming apparatus comprising:
an image forming section that forms an image consisting of a developer; and
a developer container that accommodates the developer supplied to the image forming section; and
a mounting portion in which the developer container is attachably and detachably mounted by inserting and removing the developer container,
wherein the developer container is the developer container according to claim 5.

15. An image forming apparatus comprising:
an image forming section that forms an image consisting of a developer; and
a developer container that accommodates the developer supplied to the image forming section; and
a mounting portion in which the developer container is attachably and detachably mounted by inserting and removing the developer container,
wherein the developer container is the developer container according to claim 6.

16. An image forming apparatus comprising:
an image forming section that forms an image consisting of a developer; and
a developer container that accommodates the developer supplied to the image forming section; and
a mounting portion in which the developer container is attachably and detachably mounted by inserting and removing the developer container,
wherein the developer container is the developer container according to claim 7.

17. The image forming apparatus according to claim 10,
wherein the mounting portion is provided with a recess portion into which a support portion is fitted.

18. The image forming apparatus according to claim 10,
wherein, in a case where the developer container is the developer container according to claim 4,
the mounting portion is provided with an identification matching portion that has a shape that matches the identification shape portion and enables mounting of the accommodation portion.

19. The image forming apparatus according to claim 10,
wherein, in a case where the developer container is the developer container according to claim 8,
the mounting portion is provided with a plurality of identification matching portions that have shapes that respectively match the identification shape portions of the plurality of support portions and enable mounting of the accommodation portion.

20. The image forming apparatus according to claim 10,
wherein, in a case where the developer container is the developer container according to claim 9,
the mounting portion is provided with an additional identification matching portion that has a shape that matches the additional identification shape portion and enables mounting of the accommodation portion.
